(19) United States
(12) Patent Application Publication
(10) Pub. No.: US 2009/0189831 A1
(43) Pub. Date: Jul. 30, 2009

(54) AUTOMOBILE WINDSHIELD DISPLAY

(76) Inventors: Dan Shmuel Chevion, Haifa (IL); Tal Drory, Haifa (IL); Yuval Asher Shimony, Haifa (IL); Ron Sivan, Haifa (IL)

Correspondence Address: DUKE W. YEE, YEE & ASSOCIATES, P.C, P.O BOX 802333, DALLAS, TX, 75380, US

(21) Appl. No.: 12/020,748

(22) Filed: Jan. 28, 2008

(51) Int. Cl. G09G 5/00

(52) U.S. Cl. 345/7

(57) ABSTRACT

An improved automobile. An exemplary automobile includes an engine, a set of wheels connected to the engine, a chassis connected to the engine, and an electrochromatic windshield connected to the chassis. The electrochromatic windshield is operable to darken and un-darken the electrochromatic windshield. A video projection system is also connected to the chassis. The video projection system is operable by a driver to project an overlay image on the electrochromatic windshield. The electrochromatic windshield can be darkened by activation of the video projection system and un-darkened by deactivation of the video projection system. The video projection system can be used to project a map onto the electrochromatic windshield. The video projection system can then be used to project a relative position of the driver's vehicle, other vehicles and obstructions on the map, as well as highlighting and tracking, via graphical markings, these objects as they enter the windshield's projection plane.

### BACKGROUND OF THE INVENTION

1. Field of the Invention

The present invention relates generally to an improved vehicle. More particularly, the present invention relates to a vehicle having an electrochromatic windshield upon which an overlay image can be displayed.

2. Description of the Related Art

Traditionally, drivers of vehicles turn in their seats in order to see behind them, say, for the purpose of driving in reverse. Additionally, drivers can not see past obstacles that may be obstructing the view of an intersection or nearby streets.

These problems have been addressed via the use of cameras. Some vehicles today are equipped with one or more cameras, including automobiles. An on-board dash display screen shows images captured by the cameras. Thus, drivers need not necessarily turn in their seats in order to see a live video feed of, for example, objects behind their vehicle or otherwise in the vehicle's path.

On-board dash display screens have also been connected to computer systems in order to show a map on the display screen. The position of the vehicle can be marked on the map in real time, in order to assist the driver in navigating the vehicle.

However, a problem still remains in that the driver must take his or her eyes off of the road in order to view the on-board dash display screen. Thus, current technology unintentionally creates a driving risk. Further, the traditional problem remains of not being able to see other vehicles or objects in an intersection due to obstructions.

Heads-Up Display (HUD) systems or displays attempting to solve the issue of distraction have also are known. These systems, however, have a limited field of view by virtue of the added glass pane which the system entails.

### SUMMARY OF THE INVENTION

The illustrative embodiments provide for an improved automobile. An exemplary automobile includes an engine, a set of wheels connected to the engine, a chassis connected to the engine, and an electrochromatic windshield connected to the chassis. The electrochromatic windshield is operable to darken and un-darken the electrochromatic windshield. A video projection system is also connected to the chassis. The video projection system is operable by a driver to project an overlay image on the electrochromatic windshield. The electrochromatic windshield can be darkened concurrently with activation of the video projection system and un-darkened when the video is deactivated.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an illustration of a vehicle having a projection system, comprised of one or more projector units, projecting an overlay image onto an electrochromatic windshield, in accordance with an illustrative embodiment; and

FIG. 2 is a flowchart of a method of operating a vehicle, in accordance with an illustrative embodiment.

### DETAILED DESCRIPTION OF THE PREFERRED EMBODIMENT

The illustrative embodiments provide for an improved vehicle. As used herein, vehicles include automobiles (such as but not limited to cars (e.g. sedans), trucks, station wagons, vans, mini-vans and sports utility vehicles), boats, planes, motorcycles, bicycles, and any other form of mechanized transportation. As used herein, an exemplary automobile includes an engine, a set of wheels connected to the engine, a chassis connected to the engine, and an electrochromatic windshield connected to the chassis. The electrochromatic windshield is operable to darken and un-darken the electrochromatic windshield. A video projection system is also connected to the chassis. The video projection system is operable by a driver to project an overlay image on the electrochromatic windshield. The electrochromatic windshield can be darkened concurrently with the activation of the video projection system and un-darkened when the video projection system is deactivated.

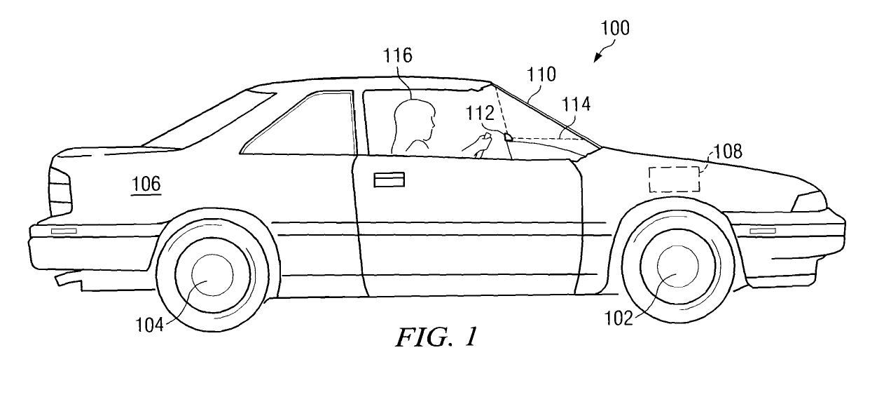

FIG. 1 is an illustration of a vehicle having a projection system, comprised of one or more projector units, projecting an overlay image onto an electrochromatic windshield, in accordance with an illustrative embodiment. Vehicle 100 includes wheel 102 and wheel 104 mounted to chassis 106. Vehicle 100 is powered by engine 108, which is operably connected to chassis 106. The illustrative example of FIG. 1 is an automobile.

Also connected to chassis 106 is electrochromatic windshield 110. Electrochromatic windshield 110 is a transparent substance that, via the use of magnetic or electrical fields, can darken or un-darken. An electrochromatic windshield 110 can be manufactured by companies that produce electrochromatic glass or mirrors, such as Gentex Corporation of Zeeland, Mich. As used herein, the term darken means that the properties of electrochromatic windshield 110 change such that less light passes through electrochromatic windshield 110, though still enough light is allowed to pass so that driver 116 can see outside of vehicle 100. The term un-darken means that the properties of electrochromatic windshield 110 change such that more light passes through electrochromatic windshield 110 relative to a darkened electrochromatic windshield 110. Electrochromatic windshield 110 can be caused to darken or un-darken in response to a user-actuated switch, or in response to actuation of video projection system 112. A switch can be placed in any convenient location, such as on the dashboard or on the steering wheel of vehicle 100.

Unless already darkened, electrochromatic windshield 110 can automatically darken in response to activation of video projection system 112 (though video projection system 112 can be actuated separately via any desired control method). Video projection system 112 then projects an overlay image onto electrochromatic windshield 110, as indicated by phantom line 114. Driver 116 can watch overlay image 114, but can simultaneously keep his or her eyes on the road and on current traffic conditions by shifting his or her vision past overlay image 114 and through electrochromatic windshield 110. Thus, driver 116 only minimally diverts his or her attention from driving when viewing overlay image 114.

In turn, video projection system 112 can be actuated manually by driver 116, or by some pre-condition. For example, video projection system 112 can be actuated by driver 116 placing the vehicle into reverse gear, causing a video image from behind vehicle 100, relative to driver 116, to automatically be projected onto electrochromatic windshield 110. Note that in this case the driver can select the viewing mode, back-facing or rear-view mirror display mode.

In rear-view mirror mode, the image is horizontally reversed, such that the image appears like a reflection in a rear-view mirror. In this manner, the steering wheel handling method is identical to its handling when the vehicle is moving forward, i.e. one turns the steering wheel into the turn.

In back-facing mode, the image displayed appears as if the driver turned and faced the rear, without the in-vehicle obstructions, such as head rests, etc. Note that if one wants to keep the natural steering behavior, where one turns the steering wheel into the turn, the steering wheel behavior needs now to be reversed. Obviously, mechanical steering columns are not suited for this purpose; however, if the car is using ‘steer-by-wire’ this effect can be readily achieved.

In the illustrative embodiment shown in FIG. 1, video projection system 112 is attached to the dashboard of vehicle 100. The dashboard is attached to chassis 106. However, video projection system 112 can be attached to any convenient location within the vehicle, such as on the ceiling of the vehicle above and behind the driver 116, or even on the rear dash or rear windshield. In still another illustrative embodiment, driver 116 can carry and then mount a portable projector on some portion of the interior of vehicle 100.

In another illustrative embodiment, a second video projection system 112 can be added. A second video projection system 112 can project a second image onto electrochromatic windshield 110. The two images can be merged to create a combined overlay image 114. In an illustrative example, by using two video projection systems 112 in color, a three-dimensional rendering of a scene can be projected onto electrochromatic windshield 110. A three-dimensional image can provide subtle visual cues to driver 116 that allow driver 116 to better gauge distances, and thereby allow driver 116 to drive in a safer manner.

In another illustrative embodiment, overlap image 114 projected onto electrochromatic windshield 110 can be used to show the relative positions, or order, of other vehicles on the map in relation to the driver's vehicle. This system is particularly useful with respect to vehicles that the driver 116 cannot directly see, due to buildings, trees, terrain, weather, or other obstructions. In the case where multiple drivers in an area all have embodiments of the present invention installed in their vehicles, the illustrative embodiments can be used to create a collaborative driving environment in which safety is greatly improved.

In an illustrative embodiment, overlay image 114 projected by the video projection system is a video feed from one or more cameras mounted to chassis 106. In an example, a camera is mounted behind vehicle 100 in order to capture images behind vehicle 100, relative to driver 116. Thus, video projection system 112 can be used to project a live video feed of images taken behind vehicle 100 onto electrochromatic windshield 110. Thus, the illustrative embodiments allow driver 116 to view video images of objects behind driver 116 while driver 116 continues to look at the road in front of him or her. Thus, the illustrative embodiments allow driver 116 to look forward, but see backward.

In another example, via the use of specialized cameras, overlay image 114 can be a magnified image taken by a zoom camera, an infrared image taken by an infrared camera, or a night vision image taken by a high light gain camera. In another illustrative embodiment, an image based on RADAR can be projected by video projection system 112 onto electrochromatic windshield 110. The RADAR system may be connected to vehicle 100. Thus, driver 116 potentially could make out details of images located far from driver 116, or could potentially drive through dark areas or even fog, simply by watching overlay image 114 on electrochromatic windshield 110.

Additionally, control software can be used to modify overlay image 114. For example, the image could be simply the scene ahead of the vehicle (the one the driver 116 would have seen had the windshield been transparent and no image projected on it) but with limited contrast, in order to eliminate the glare of headlights of oncoming traffic. An overlay image 114 can be further modified by projecting overlay image 114 onto only a portion of electrochromatic windshield 110. The size of the portion of electrochromatic windshield 110 upon which overlay image 114 is displayed may be controlled by driver 116.

In use, the illustrative embodiments provide for a method of operating a vehicle. An electrochromatic windshield of the vehicle is darkened. Onto electrochromatic windshield 110 is projected an overlay image 114. Projecting is performed by a video projection system 112 connected to vehicle 100. Projecting is performed while vehicle 100 is in motion. Overlay image 114 can be a video feed of a camera attached to the vehicle, wherein the camera is oriented to receive images behind the vehicle relative to a facing of a driver 116 of the vehicle.

Overlay image 114 can be a variety of images. For example, overlay image 114 can be a map, a live video feed of cameras mounted to the vehicle or elsewhere, or a position of one or more vehicles or objects relative to driver 116. Because overlay image 114 need not be generated inside the vehicle, video feed from a camera mounted over an intersection can be displayed on electrochromatic windshield 110. Thus, driver 116 can have a birds-eye view of an intersection, allowing driver 116 to perceive dangers behind obstructions that would otherwise block the view of driver 116.

Overlay image 114 could also be that of captured video of a business meeting. Thus, the illustrative embodiments allow for driver 116 and/or the occupants to participate in a meeting while driving. Overlay image 114 can even be a movie, video recording, or the current display produced by a data processing system. Thus, the illustrative embodiments would allow driver 116 to see the computer screen being operated by some other person.

In another illustrative embodiment, a synthetic scene can be projected onto the electrochromatic windshield 110. A synthetic scene can be a presentation of the vehicle's situation with regards to other vehicles from different viewing perspectives.

Additionally, vehicle-to-vehicle (V2V) and vehicle-to-infrastructure communication (V2I) capabilities could provide driver 116 with additional information which could be displayed in a non-distracting manner, thereby helping driver 116 orientation. Such capabilities could, for example, inform driver 116 of approaching vehicles that he or she cannot see otherwise, due to road bends, buildings, weather conditions, or other obstructions.

The illustrative embodiments can be varied. For example, overlay images 114 can be projected or otherwise displayed on goggles worn by driver 116. In this case, electrochromatic glass can be incorporated into the goggles so that the user can see through the goggles and also perceive overlay image 114 being displayed on the goggles.

The illustrative embodiments provide for an improved vehicle. An exemplary vehicle includes an engine, a set of wheels connected to the engine, a chassis connected to the engine, and an electrochromatic windshield connected to the chassis. Electrochromatic windshield 110 is operable to darken and un-darken electrochromatic windshield 110. Video projection system 112 is also connected to the chassis 106. Video projection system 112 is operable by a driver 116 to project overlay image 114 on electrochromatic windshield 110. Electrochromatic windshield 110 can be darkened by activation of video projection system 112 and un-darkened by deactivation of video projection system 112.

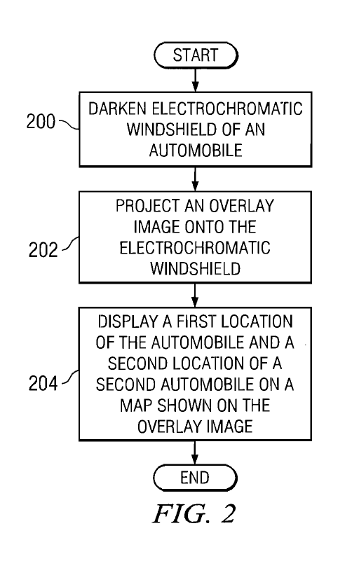

FIG. 2 is a flowchart of a method of operating a vehicle, in accordance with an illustrative embodiment. The process shown in FIG. 2 can be implemented using the devices and methods described with respect to FIG. 1. In particular, the process shown in FIG. 2 can be implemented using a video projection system, such as video projection system 112 shown in FIG. 1.

The process begins as the video projection system darkens the electrochromatic windshield of the vehicle (step 200). However, other methods of darkening the electrochromatic windshield can be used, such as a user-actuated switch, voice command, or any other means for causing darkening of the electrochromatic windshield.

Next, the video projection system projects an overlay image onto the electrochromatic windshield (step 202). In an illustrative example, projection is performed while the vehicle is in motion. The overlay image can be a video feed of a camera attached to the vehicle, wherein the camera is oriented to receive images behind the vehicle relative to a facing of a driver of the vehicle. The overlay image can also be a map.

Thus, in an optional illustrative embodiment, the video projection system highlights, via the use of computer generated markings (such as brackets with attached text), vehicles which are coordinating their location and velocity with the driver's vehicle, in order to prevent collisions (step 204), with the process terminating thereafter. A proposed coordinating method is documented under “Driver/vehicle interface combining dynamic function modification of vehicle controls and haptic feedback”, Dan Chevion, attorney docket number IL8-2006-0226. Thus, the illustrative embodiments provide for cooperative driving in which multiple drivers all see each others' vehicles on respective maps displayed on respective windshields and highlighted on the windshields when they are within the drivers' field of view. In this manner, drivers can recognize potential obstructions and prevent accidents before the drivers can physically see each other due to obstructions.

In another optional illustrative embodiment, the video projection system projects a second overlay image on the electrochromatic windshield. The second overlay image is merged with the first overlay image to form a combined overlay image. Such an overlay image can create a three-dimensional perception.

The instructions used to control the video projection system, the overlay image, and/or the electrochromatic windshield can take the form of an entirely hardware embodiment, an entirely software embodiment or an embodiment containing both hardware and software elements. In a preferred embodiment, the invention is implemented in a combination of hardware (such as the electrochromatic windshield) and software, which includes but is not limited to firmware, resident software, microcode, etc.

Furthermore, the software used to control the video projection system, the overlay image, and/or the electrochromatic windshield can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters. The video projection system can receive data from network adapters in order to project an overlay image onto the electrochromatic windshield based on data received from remote cameras or remote data processing systems.

The description of the embodiments of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. An automobile comprising:
an engine;
a set of wheels connected to the engine;
a chassis connected to the engine;
an electrochromatic windshield connected to the chassis, wherein the electrochromatic windshield is operable to darken and un-darken the electrochromatic windshield; and
a video projection system connected to the chassis, wherein the video projection system is operable by a driver to project an overlay image on the electrochromatic windshield, and wherein the electrochromatic windshield is darkened by activation of the video projection system and un-darkened by deactivation of the video projection system.

2. The automobile of claim 1 wherein the video projection system is connected to a dashboard that is connected to the chassis.

3. The automobile of claim 1 wherein the overlay image comprises a video feed captured by a camera mounted to the chassis.

4. The automobile of claim 1 wherein the overlay image comprises a map of an area surrounding the automobile.

5. The automobile of claim 4 wherein the overlay image further comprises a position of a second vehicle on the map.

6. The automobile of claim 1 further comprising:
a second video projector connected to the chassis, wherein the second video projector is operable to project a second overlay image on the electrochromatic windshield, and wherein the second overlay image is merged with the overlay image to create a combined overlay image.

7. The automobile of claim 1 wherein the overlay image comprises a map and positions of vehicles within a vicinity of the automobile on the map.

8. The automobile of claim 6 wherein the combined overlay image comprises a three dimensional image.

9. The automobile of claim 1 wherein the overlay image comprises a video feed of a camera attached to the chassis, wherein the camera is oriented to receive images behind the automobile relative to a facing of the driver, and wherein the video projection system is operable to project the overlay image and provide a perception that the automobile is moving forward relative to the facing of the driver as the automobile is moving backward relative to the facing of the driver.

10. A method of operating an automobile, the method comprising:
darkening an electrochromatic windshield of the automobile;
projecting onto the electrochromatic windshield an overlay image, wherein projecting is performed by a video projection system connected to the car, and wherein projecting is performed while the vehicle is in motion.

11. The method of claim 10 wherein the overlay image comprises a video feed of a camera attached to the automobile, wherein the camera is oriented to receive images behind the automobile relative to a facing of a driver of the automobile, and wherein the video projection system is operable to project the overlay image while providing the perception that the automobile is moving forward relative to the facing of the driver as the automobile is moving backward relative to the facing of the driver.

12. The method of claim 10 wherein the overlay image comprises a map.

13. The method of claim 12 further comprising:
displaying and highlighting on the windshield locations of vehicles on the map, relative to the automobile.

14. The method of claim 10 further comprising:
projecting a second overlay image on the electrochromatic windshield, wherein the second overlay image is merged with the overlay image to form a combined overlay image.

15. The method of claim 15 wherein the combined overlay image comprises a three dimensional image.
